(19) United States
(12) Patent Application Publication
(10) Pub. No.: US 2010/0151331 A1
(43) Pub. Date: Jun. 17, 2010

(54) Positive active material and rechargeable lithium battery comprising same

(75) Inventors: Yang-Kook Sun, Seoul (KR); Byung-Chun Park, Ansan-si (KR); Hyung-Bae Kim, Cheonan-si (KR)

Correspondence Address: LEXYOUME IP GROUP, LLC, 5180 PARKSTONE DRIVE, SUITE 175, CHANTILLY, VA, 20151, US

(73) Assignee: EnerCeramic Inc., Namyangju-si (KR)

(21) Appl. No.: 12/316,678

(22) Filed: Dec. 16, 2008

(51) Int. Cl. H01M 4/58

(52) U.S. Cl. 429/231.95

(57) ABSTRACT

The present invention relates to a positive active material for a rechargeable lithium battery and a rechargeable lithium battery including the same. The positive active material includes an active compound that can intercalate/deintercalate lithium ions, and a bismuth (Bi)-based compound on the surface of the active compound. The bismuth (Bi)-based compound in the positive active material of the present invention decreases resistance against acid generated around a positive active material, and plays a role of suppressing structural change of the positive active material and its reaction with an electrolyte solution and preventing dissolution of transition elements therein. Accordingly, the positive active material of the present invention can improve storage and cycle life characteristics at a high temperature. In addition, it can increase charge and discharge, cycle life, and rate characteristics of a rechargeable lithium battery as well as improve mobility of lithium ions in the electrolyte solution.

### BACKGROUND OF THE INVENTION

(a) Field of the Invention

The present invention provides a positive active material for a rechargeable lithium battery, and a rechargeable lithium battery including the same. In particular, it provides a positive active material for a rechargeable lithium battery having excellent cycle life and high rate characteristics, and a rechargeable lithium battery including the same.

(b) Description of the Related Art

There has been remarkably increasing demand for a rechargeable battery as a power source for portable electronic devices such as PDAs, mobile phones, laptop computers, and the like, as well as for electric bikes, electric vehicles, and the like, because of their capacity to be repeatedly charged and discharged. In particular, performance of these electronic devices necessarily depends on a rechargeable battery as a power source. Accordingly, there is a requirement for a battery with high performance.

In general, a battery should be stable at a high temperature and should have good charge and discharge, cycle life, and high rate characteristics. A rechargeable lithium battery has gained attention due to its high voltage and high energy density.

A commercially available small rechargeable lithium battery includes LiCoO₂ as a positive electrode and carbon as a negative electrode. Further, Japanese Moli Energy Corp. has manufactured a battery including LiMn₂O₄ as a positive electrode, but it is used very little compared with LiCoO₂.

The LiCoO₂ has a stable charge/discharge characteristic, excellent electronic conductivity, high thermal stability, and an even discharge voltage characteristic. However, since little Co is deposited, and it is expensive and poisonous to a human body, there is a requirement for a new positive electrode material.

Accordingly, LiNiO₂, LiCoₓNi₁₋ₓO₂, and LiMn₂O₄ are being actively researched to replace LiCoO₂ as a positive electrode material. However, these compounds are not being employed due to the following problems.

The LiNiO₂ has a problem in thermal stability as well as synthesis, and therefore is not yet commercially available. The LiMn₂O₄ is commercially manufactured as a low cost product but has a relatively smaller theoretical capacity of 148 mAh/g than the other materials due to its spinel structure. Since it also has a three-dimensional tunnel structure, it has large diffusion resistance during intercalation/deintercalation of lithium ions.

In addition, it has a lower diffusion coefficient than LiCoO₂ and LiNiO₂ that have a two-dimensional structure. In addition, it has poor cycle life characteristics due to the Jahn-Teller effect. In particular, it has worse high temperature characteristics than LiCoO₂ at 55° C. or higher, so it is not widely used for a battery. In addition, a rechargeable lithium battery including this positive active material has sharply deteriorated cycle life during repeated charges and discharges. This is because moisture inside a battery and other influences decomposes an electrolyte or deteriorates an active material therein, resultantly increasing internal resistance in the battery. In particular, the positive active material tends to have a sharply degraded reaction at a high temperature. Many efforts are being made to solve this problem.

Korean Laid-Open Patent Publication No. 10-277796 discloses a method of coating a metal such as Mg, Al, Co, K, Na, Ca, and the like on the surface of a positive electrode material and heat-treating it under an oxidation atmosphere.

In addition, the recent Korean Laid-Open Patent Publication No. 2003-32363 discloses a method of coating a hydroxide including a metal such as Mg, Al, Co, K, Na, Ca, Si, Ti, Sn, V, Ge, Ga, B, As, and Zr, an oxyhydroxide, an oxycarbonate, and a hydroxycarbonate salt on the surface of a positive active material. However, this method also does not solve the cycle life decrease problem of a positive active material, particularly LiCoO₂, at a high voltage.

Recently, a method of coating AlF₃ on the surface of a LiCoO₂ active material and improving the high rate characteristics at 4.5 V Li/Li⁺ without decreasing capacity has been reported (Electrochem. Commun., 8(5), 821-826, 2006). However, an oxyfluoride compound having a semiconductor characteristic is known to have higher electronic conductivity than a fluoride compound insulator, improving the electrochemical characteristics (Journal of the Electrochemical Society, 153, 1A159-A170, 2006).

This surface-modified positive active material can remarkably improve the electrochemical characteristics, but does little to suppress its rapid reaction with an electrolyte solution at a high temperature.

### SUMMARY OF THE INVENTION

An exemplary embodiment of the present invention provides a positive active material for a rechargeable lithium battery having improved storage and cycle life characteristics at a high temperature.

Another embodiment of the present invention provides a rechargeable lithium battery including the positive active material and having improved charge and discharge, cycle life, high voltage, and high rate characteristics, as well as improved discharge potential.

Yet another embodiment of the present invention provides a positive active material for a rechargeable lithium battery including an active compound that can intercalate/deintercalate lithium ions and a bismuth (Bi)-based compound coated on the surface thereof.

According to an embodiment of the present invention, provided is a rechargeable lithium battery including a positive electrode including the positive active material, a negative electrode including a negative active material, and a non-aqueous electrolyte.

The bismuth-based compound on the positive active material decreases resistance against acid generated around the positive active material, and plays a role of suppressing structural change of the positive active material and its reaction with an electrolyte solution and preventing dissolution of transition elements therein. Accordingly, the positive active material of the present invention can improve storage and cycle life characteristics of a chargeable lithium battery at a high temperature. In addition, it can improve mobility of lithium ions in the electrolyte solution, and can improve charge and discharge, cycle life, and rate characteristics, as well as the discharge potential of a rechargeable lithium battery.

### BRIEF DESCRIPTION OF THE DRAWING

FIG. 1 is the transmission electron microscope (TEM) photograph of LiMn₂O₄ that is surface-modified with Bi₂O₃ according to Example 1 of the present invention.

### DETAILED DESCRIPTION OF THE INVENTION

The present invention relates to a positive active material for a rechargeable lithium battery. The positive active material includes an active compound that can intercalate/deintercalate lithium ions, and a bismuth (Bi)-based compound on the surface of the active compound.

The bismuth-based compound has resistance against reaction with acid produced in an electrolyte solution, and prevents an active compound that plays a role of a positive active material during the charges and discharges at a high temperature from directly reacting with the electrolyte solution. The active compound has no particular limit as long as it can intercalate/deintercalate lithium. It can suppress reaction with acid produced in the electrolyte solution, and can thereby improve characteristics of a rechargeable lithium battery.

The bismuth-based compound may be prepared by selecting one from a negative ion-combined compound such as an oxide, a nitride, a sulfide, a fluoride, and the like based on a bismuth metal element, or mixing more than one thereof. In addition, it may include a compound including a substituent such as an amine group, an acetate group, and the like. In other words, the bismuth-based compound may be selected from the group consisting of bismuth-included oxide, bismuth-included nitride, bismuth-included sulfide, bismuth-included fluoride, a bismuth-included amine compound, a bismuth-included acetate compound, and a mixture thereof.

Specifically, the bismuth-based compound may be selected from the group consisting of Bi₂O₃, BiOF, BiF₃, BiF₅, NH₄BiF₄, NH₄BiF₆, NH₄Bi₃F₁₀, Bi(C₂H₃O₂)₃, and mixtures thereof.

According to one embodiment of the present invention, a bismuth-based compound on the surface of an active compound has a nano-size. Herein, the bismuth-based compound has a size ranging from 3 nm to 900 nm, or ranging from 3 nm to 500 nm in another embodiment. When it has a size of 3 nm or less, these nano-sized bismuth-based compound particles are aggregated into larger particles of a size of 900 nm. When is the larger particles are formed to be 900 nm or larger, it may increase surface resistance of a positive active material, rather deteriorating battery characteristics.

In the positive active material of the present invention, the bismuth-based compound can be coated as a layer on the surface of an active compound, or sporadically as an island thereon.

When it is coated as a layer, it may be 3 to 500 nm thick. In another embodiment, it may be 5 to 500 nm thick, or 5 to 300 nm thick in still another embodiment. When it is 3 nm thick or less, it may have little effect. When it is 500 nm thick or more, it may deteriorate the electrochemical characteristics of an active compound.

In addition, when it is coated as an island, the bismuth-based compound has an area of 1 to 100% based on 100% of the active compound surface area. In other embodiments, it may have an area of 5 to 100% or an area of 10 to 100%. When it has an area of 1% or less, it may have little effect. When it is coated as an island, it has an area of 100%.

Regardless of its coating on the surface of an active compound, it may be included in an amount of 0.001 to 15 mol % based on the active compound, or in an amount of 0.005 to 10 mol %. In still in another embodiment, it may be included in an amount of 0.005 to 8 mol %. When it is included in an amount of 0.001 mol % or less, it may have little effect. When it is included in an amount of 15 mol % or more, it may deteriorate electrochemical characteristics such as discharge capacity, high rate characteristics, and the like.

The active compound may include any common compound for a rechargeable lithium battery with no particular limit, but may include layered lithium composite metal oxides having hexagonal, monoclinic, and orthorhombic crystal structures, spinel-based lithium composite metal oxides having cubic crystal structures, or olivine-based lithium composite metal oxides. The lithium composite metal oxides may be represented by at least one of the following Formulas 1 to 7.

LiₐNiₓCo_{y}Mn_{z}M_{1-x-y-z}O₂Q_{σ} [Chemical Formula 1]

In the above Formula 1, M is an element selected from the group consisting of B, Mg, Al, Cr, V, Ti, Fe, Zr, Zn, Si, Y, Nb, Ga, Sn, Mo, W, and combinations thereof, Q is a halogen or sulfur, 1.0≦a≦1.2, 0≦x≦0.95, 0≦y≦0.7, 0≦z≦0.7, 0≦1−x−y−z≦0.3, and 0≦σ≦0.1.

LiₐCo₁₋ₓMₓO₂Q_{σ} [Chemical Formula 2]

In the above Formula 2, M is selected from the group consisting of Mg, B, Al, Cr, V, Ti, Fe, Zr, Zn, Si, Y, Nb, Ga, Sn, Mo, W, and combinations thereof, Q is a halogen or sulfur, 1.0≦a≦1.2, 0≦x≦0.1, and 0≦σ≦0.1.

LiₐMn₁₋ₓMₓO₂Q_{σ} [Chemical Formula 3]

In the above Formula 3, M is an element selected from the group consisting of B, Mg, Al, Cr, V, Ti, Fe, Zr, Zn, Si, Y, Nb, Ga, Sn, Mo, W, and combinations thereof, Q is a halogen or sulfur, 1.0≦a≦1.2, 0≦x≦0.5, and 0≦σ≦0.1.

LiₐMn₂₋ₓMₓO₄Q_{σ} [Chemical Formula 4]

In the above Formula 4, M is an element selected from the group consisting of B, Li, Mg, Al, Ca, Sr, Cr, V, Ti, Fe, Co, Ni, Zr, Zn, Si, Y, Nb, Ga, Sn, Mo, W, and combinations thereof, Q is a halogen or sulfur, 1.0≦a≦1.3, 0≦x≦0.2, and 0≦σ≦0.1.

LiₐMn₂₋ₓMₓO₄Q_{σ} [Chemical Formula 4]

In the above Formula 5, M is an element selected from the group consisting of B, Li, Mg, Al, Ca, Sr, Cr, V, Ti, Fe, Co, Ni, Zr, Zn, Si, Y, Nb, Ga, Sn, Mo, W, and combinations thereof, Q is a halogen or sulfur, 1.0≦a≦1.3, 0.3≦x≦0.7, and 0≦σ≦0.1.

Li₄₊ₐTi₄₋ₓMₓO₁₂Q_{σ} [Chemical Formula 6]

In the above Formula 6, M is an element selected from the group consisting of Li, Mg, Al, Ca, Sr, Cr, V, Ti, Fe, Co, Ni, Zr, Zn, Si, Y, Nb, Ga, Sn, Mo, W, and combinations thereof, Q is a halogen or sulfur, 0≦a≦0.1, 0≦x≦0.1, and 0≦σ≦0.1.

LiMₓPO₄Q_{σ} [Chemical Formula 7]

In the above Formula 7, M is an element selected from the group consisting of Co, Ni, Mn, Fe, Mg, V, Ti, Fe, Zr, Zn, Si, Y, Nb, Ga, Sn, Mo, W, and combinations thereof, Q is a halogen or sulfur, 0≦a≦0.1, 0≦x≦0.1, and 0≦σ≦0.02.

The lithium composite metal oxides of the above Formulas 1 to 2 have a hexagonal crystal structure. The lithium composite metal oxide of the above Formula 3 has a monoclinic or orthorhombic crystal structure, the lithium composite metal oxides of the above Formulas 4 to 7 have a cubic crystal structure, and the lithium composite metal oxide of the above Formula 8 has an olivine structure.

These aforementioned positive active materials of the present invention increase resistance against acid and suppress structural change and reaction with an electrolyte, as well as facilitate intercalation/deintercalation of lithium, thereby reducing battery capacity decrease. In addition, they can improve mobility of lithium ions in the electrolyte and improve discharge potential, improving charge and discharge, cycle life, and rate characteristics of a rechargeable lithium battery. Furthermore, they can sharply improve cycle life and storage characteristics at a high temperature.

Hereinafter, a method of preparing a positive active material of the present invention is illustrated in detail. However, this manufacturing method is exemplary and includes any method in which a bismuth-based compound is coated on the surface of an active compound. In addition, the bismuth-based compound can be coated as a layer or an island by appropriately regulating the following process conditions. However, this method is not illustrated in detail.

The method of coating the bismuth-based compound on the surface of an active compound may be performed by using a solvent or no solvent. The method of using a solvent can vary depending on temperature, synthesis pH, synthesis time, and synthesis concentration of the solvent.

First, the method includes adding a bismuth-based compound precursor to a solvent, preparing a mixed solution by adding an active compound that can intercalate/deintercalate lithium ions to the solvent, and drying the mixed solution to remove the solvent. In addition, after the drying process, it may include a heat treatment.

The bismuth precursor may be selected from the group consisting of bismuth-included oxide, bismuth-included nitride, bismuth-included sulfide, bismuth-included fluoride, a bismuth-included amine compound, a bismuth-included acetate compound, and a mixture thereof.

In the manufacturing method, the active compound is added to the solvent first, and a bismuth-based compound precursor can be added thereto.

Regardless of the order of adding the active compound and the bismuth-based compound precursor, the addition and preparation of the mixed solution may be performed at a temperature ranging from −10 to 100° C. In another embodiment, these can be performed at a temperature ranging from 5 to 95° C.

When the bismuth-based compound is added at −10° C. or lower, the reaction may not occur quickly, leaving many impurities due to non-reactants. When it is added at 100° C. or higher, the reaction occurs so quickly that it may be difficult to synthesize nano-size particles and to regulate reaction concentration due to evaporation of the solvent.

This method can coat an amorphous bismuth-based compound on the surface of an active compound.

On the other hand, a chelating agent can be additionally added when the bismuth-based precursor compound is added.

The chelating agent may include one or more of an ammonium positive ion-containing compound, an organic acid, a polyelectrolyte, and the like.

The ammonium positive ion-containing compound may include NH₄OH, NH₄₂SO₄, NH₄NO₃, or a combination thereof. The organic acid may include citric acid, glycolic acid, or a combination thereof. In addition, the polyelectrolyte may include polysodium styrene sulfonate, polypeptide, polyacrylic acid, or a combination thereof.

When the chelating agent is added, it may be used in an amount of 1 to 10 moles based on 1 mol of the bismuth-based compound precursor. When it is used in an amount of 1 mol or less based on 1 mol of the bismuth-based compound precursor, it may have little effect. When it is used in an amount of 10 moles or more, it may not secure the desired pH.

The bismuth-based compound precursor may be used in an amount of 0.001 to 15 mol % based on an active compound. In other embodiments, it may be included in an amount of 0.005 to 10 mol % or in an amount of 0.005 to 8 mol %. When it is used in an amount of 0.001 mol % or less, it may have little effects, and when it is used in an amount of 15 mol % or more, it may deteriorate electrochemical characteristics such as discharge capacity and high rate characteristics.

The solvent may include any solvent as long as it can dissolve a bismuth-based compound precursor. For example, it may be selected from the group consisting of water, alcohol, and ether, singularly or as a mixture. The alcohol may include a C1 to C4 lower alcohol and the like. In particular, it may be selected from the group consisting of methanol, ethanol, isopropanol, and combinations thereof. The ether may include ethylene glycol, butylene glycol, or the like.

The drying can be performed by using a common device. It is also performed at a temperature ranging from 110 to 200° C. for 5 to 30 hours under a vacuum condition to prevent transformation of the compound.

The heat treatment should be performed at a temperature ranging from 300 to 1000° C. for 2 to 10 hours. When it is performed at 300° C. or lower, a prepared positive active material may include impurities, having deteriorated purity. When it is performed at 1000° C. or higher, the temperature is higher than the melting point of the bismuth-based compound, or particles may grow too large.

The method of using no solvent can be performed by using a mill.

In addition, a bismuth compound itself instead of the bismuth compound precursor can be coated on the surface of an active compound using spraying, coating, or printing lithography methods, and the like.

Accordingly, the positive active material of the present invention can be usefully applied to a rechargeable lithium battery.

According to a second embodiment of the present invention, provided is a rechargeable lithium battery including a positive electrode including the positive active material, a negative electrode including a negative active material, and a non-aqueous electrolyte.

The rechargeable lithium battery has much better output characteristics at a higher rate. It also has excellent thermal stability and high temperature characteristics as well as excellent battery capacity and cycle life characteristics.

In general, a rechargeable lithium battery can be classified as a lithium ion battery, a lithium ion polymer battery, and a lithium polymer battery depending on kinds of a separator and an electrolyte, and can be shaped as a cylinder, a prism, a coin, a pouch, and the like.

According to a third embodiment of the present invention, a rechargeable lithium battery includes a negative electrode, a positive electrode, and an electrolyte. The rechargeable lithium battery is representatively fabricated by disposing a separator between negative and positive electrodes to prepare an electrode assembly, and injecting an electrolyte therein to impregnate the negative and positive electrodes and the separator.

The positive electrode includes a positive active material according to the present invention. The positive electrode can be fabricated by preparing a composition for a positive active material by mixing the positive active material of the present invention, a conductive material, and a binder, coating the composition on a positive electrode current collector such as an aluminum foil, and compressing it.

The binder may include polyvinylalcohol, carboxylmethylcellulose, hydroxypropylcellulose, diacetylcellulose, polyvinylchloride, polyvinylpyrrolidone, polytetrafluoroethylene, polyvinylidene fluoride, polyethylene, polypropylene, or the like, but is not limited thereto.

In addition, the conductive material may include any conductive material as long as it is used for a rechargeable battery, for example a metal powder such as natural graphite, artificial graphite, carbon black, acetylene black, ketjen black, carbon fiber, copper, nickel, aluminum, silver, and the like, or a metal fiber and the like.

The negative electrode includes a negative active material. The negative active material may include a compound that can reversibly intercalate/deinterclate lithium. Specific examples of the negative active material are a carbonaceous material such as artificial graphite, natural graphite, graphitized carbon fiber, amorphous carbon, and the like, and a compound that can intercalate/deintercalate lithium ions such as lithium, an alloy such as a lithium-included alloy, an intermetallic compound, an organic compound, an inorganic compound, a metal complex, an organic polymer compound, and the like. These compounds can be used singularly or as a mixture thereof, as long they do not damage effects of the present invention.

Examples of the carbonaceous material may be selected from the group consisting of coke, thermal decomposition carbon, natural graphite, artificial graphite, meso-carbon microbeads, graphitized mesophase spherules, vapor phase growth carbon, glass carbon, carbon fiber including polyacrylonitriles, pitches, celluloses, vapor phase growth carbon-based fiber, amorphous carbon, and carbon-fired organic material. They can be used singularly or as a mixture as long as they do not damage effects of the present invention.

The lithium alloy may include a Li—Al-based alloy, a Li—Al—Mn-based alloy, a Li—Al—Mg-based alloy, a Li—Al—Sn-based alloy, a Li—Al—In-based alloy, a Li—Al—Cd-based alloy, a Li—Al—Te-based alloy, a Li—Ga-based alloy, a Li—Cd-based alloy, a Li—In-based alloy, a Li—Pb-based alloy, a Li—Bi-based alloy, a Li—Mg-based alloy, and the like. The alloy and intermetallic compound may include a compound including a transition metal and silicon, a compound including a transition metal and tin, or the like. In another embodiment, it may particularly include a nickel-silicon compound.

Like the positive electrode, the negative electrode can be fabricated by preparing a composition for a negative active material by mixing the negative active material, a binder, and selectively a conductive material and coating the composition on a negative electrode current collector such as a copper foil.

The electrolyte may include a non-aqueous electrolyte, a well-known solid electrolyte, or the like, which dissolve a lithium salt.

The lithium salt has no particular limit, but may include LiClO₄, LiBF₄, LiPF₆, LiAlCl₄, LiSbF₆, LiSCN, LiCF₃SO₃, LiCF₃CO₂, Li(CF₃SO₂)₂, LiAsF₆, LiN(CF₃SO₂)₂, LiB₁₀Cl₁₀, LiBOB (lithium bis(oxalato)borate), a lower aliphatic carbonic acid lithium, chloroborane lithium, tetraphenylboric acid lithium, and imides such as LiN(CF₃SO₂)(C₂F₅SO₂), LiN(CF₃SO₂)₂, LiN(C₂F₅SO₂)₂, LiN(CF₃SO₂, C₄F₉SO₂), and the like.

The lithium salts can be used singularly or as a mixture thereof, as long as they do not damage effects of the present invention. In particular, LiPF₆ is used.

In addition, carbon tetrachloride, trifluoride chloride ethylene, phosphoric acid salt, or the like can be added to an electrolyte in order to make the electrolyte inflammable.

Further, the electrolyte may include a solid electrolyte selected from the group consisting of an inorganic solid electrolyte, an organic solid electrolyte, and a mixture thereof, rather than the aforementioned electrolyte.

The inorganic solid electrolyte may be selected from the group consisting of Li₄SiO₄, Li₄SiO₄—Lil-LiOH, Li₃PO₄—Li₄SiO₄, Li₂SiS₃, Li₃PO₄—Li₂S—SiS₂, a phosphorus sulfide compound, and mixtures thereof.

The organic solid electrolyte may include polyethylene oxide, polypropylene oxide, polyvinyl alcohol, polyvinylidene fluoride, fluorinepropylene, and the like, a derivative thereof, a mixture thereof, a copolymer thereof, or the like.

The non-aqueous organic solvent plays a role of a medium for transferring ions related to electrochemical reaction of a battery. Examples of the non-aqueous organic solvent may include carbonate-based, ester-based, ether-based, or ketone-based solvents.

The carbonate-based solvent may be at least one selected from the group consisting of cyclic carbonate, cyclic carbonic acid ester, and a mixture thereof. The cyclic carbonate may be selected from the group consisting of ethylene carbonate (EC), propylene carbonate (PC), butylene carbonate (BC), vinylene carbonate (VC), and a mixture thereof. In addition, the cyclic carbonic acid ester may be selected from the group consisting of noncyclic carbonates such as dimethyl carbonate (DMC), diethyl carbonate (DEC), ethyl methyl carbonate (EMC), dipropylcarbonate (DPC), and the like, aliphatic carbonic acid esters such as methyl formate, methyl acetate, methyl propionate, ethyl propionate, and the like, [symbol] -butyrolactone (GBL), and mixtures thereof. The aliphatic carbonic acid ester may be included at 20 volume % or less if necessary.

A separator can be disposed between positive and negative electrodes depending on kinds of a rechargeable lithium battery. The separator may include polyethylene, polypropylene, polyvinylidene fluoride, or multilayers thereof, a double layer of polyethylene/polypropylene, a triple layer of polyethylene/polypropylene/polyethylene, a triple layer of polypropylene/polyethylene/polypropylene, and a mixed multilayer thereof.

The following examples illustrate the present invention in more detail. However, it is understood that the present invention is not limited by these examples.

### EXAMPLES

### Preparation of Positive Active Material

### Example 1

### Preparation of a Positive Active Material Including a Surface-Modifying Layer Including Bi₂O₃

50 g of LiMn₂O₄ was put in 600 ml of distilled water in an agitating reactor. NH₄OH was used to adjust the pH of the mixture to 10. Then, 0.25 mol % of Bi(NO₃)₃.5H₂O based on the LiMn₂O₄ was dissolved in 400 ml of distilled water.

The Bi(NO₃)₃.5H₂O solution was maintained at 30° C. and slowly added to the former LiMn₂O₄ solution while agitating it. The mixture solution was agitated for 6 hours and filtrated to prepare LiMn₂O₄ having Bi(OH)₃ on the surface thereof.

The prepared compound was dried at a temperature of 110° C. for 12 hours and heat-treated at 400° C. for 5 hours, preparing a surface-modified positive active material, LiMn₂O₄ having Bi₂O₃ on the surface thereof. The positive active material included 0.25 mol % of Bi₂O₃ based on LiMn₂O₄. The Bi₂O₃ was coated as an island shape in an area of 50-60% based on 100% of the surface area of LiMn₂O₄.

### Example 2

A positive active material was prepared by the same surface-modifying method as Example 1, except for exchanging the active compound with LiMn_{1.5}Ni_{0.5}O₄.

### Example 3

### Preparation of a Positive Active Material Including a Surface-Modifying Layer Including BiOF

0.75 mol % of NH₄F based on LiMn₂O₄ was dissolved in 600 ml of distilled water in an agitating reactor. Next, 50 g of LiMn₂O₄ was added to the solution. Then, NH₄OH was used to adjust the pH of the resulting solution to 7.

Further, 0.25 mol % of Bi NO₃₃.5H₂O based on LiMn₂O₄ was dissolved in 400 ml of distilled water, preparing a bismuth-based compound precursor solution.

The bismuth-based compound precursor solution was maintained at 30° C. and slowly added to the agitating reactor. The mixed solution was agitated for 6 hours and filtrated to prepare LiMn₂O₄ having NH₄Bi₃F₁₀ on the surface thereof.

The resulting product was dried at a temperature of 110° C. for 12 hours and heat-treated at 400° C. for 5 hours, preparing a positive active material including a coating layer including BiOF on the surface of LiMn₂O₄. The positive active material included 0.25 mol % of BiOF coated on LiMn₂O₄. The BiOF was coated to be 10 nm thick as a layer.

### Example 4

A positive active material was prepared by the same surface-modifying method as in Example 3, except for putting LiMn_{1.5}Ni_{0.5}O₄ in an agitating reactor as a positive active material.

### Comparative Example 1

LiMn₂O₄ was used as a positive active material.

### Comparative Example 2

LiMn_{1.5}Ni_{0.5}O₄ was used as a positive active material.

### Experimental Example 1

### Surface Characteristic Analysis

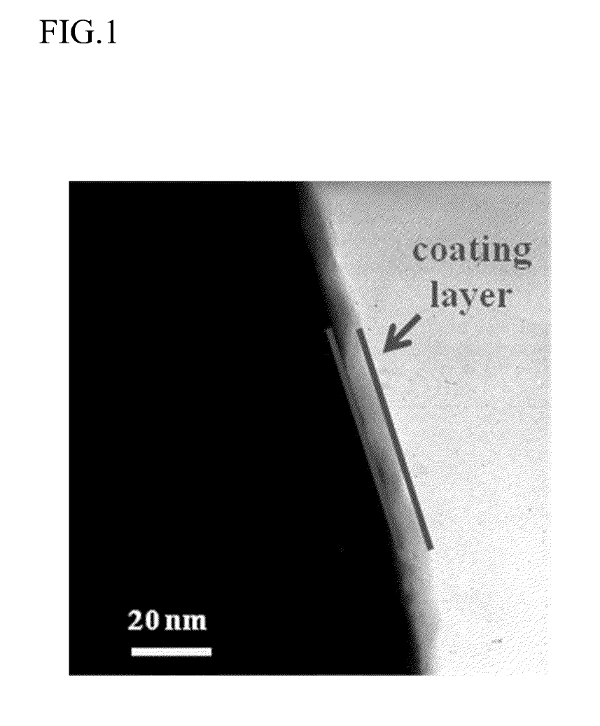

FIG. 1 shows examination results of the positive active material including a coating layer including Bi₂O₃ according to Example 1 by using a transmission electron microscope (TEM) (JEM 2000, JEOL Co., Japan).

Referring to FIG. 1, the positive active material of Example 1 was coated on the surface as a fine Bi₂O₃ powder.

Fabrication of a Half-Cell

In order to evaluate characteristics of the positive active materials of Examples 1 to 4 and Comparative Examples 1 and 2, a slurry was prepared by mixing the positive active materials of each of Examples 1 to 4 and Comparative Examples 1 to 2, acetylene black, graphite (KS6, Lonza Co.) as a conductive material, and polyvinylidene fluoride (PVdF) as a binder in a weight ratio of 85:3.75:3.75:7.5. The slurry was uniformly coated to be 20 μm thick on an aluminum film, dried at 110° C., and pressed with a roll press, fabricating a positive electrode.

The positive electrode was used together with lithium metal as a counter electrode and an electrolyte solution prepared by dissolving 1 mol of LiPF₆ in a mixed solvent of ethylene carbonate and dimethyl carbonate in a volume ratio of 1:1 in a common manufacturing process, fabricating a 2032 coin cell.

### Experimental Example 2

### Evaluation of a Half Coin Cell

### Cycle Life Characteristic Evaluation

The half coin cell was evaluated regarding cycle life characteristics at a high temperature. The evaluation of the cycle life characteristics at a high temperature was performed in a voltage range of 3.0 to 4.3 V at 0.7 C-rate at 55° C.

TABLE 1

| | | | Capacity |
|---|---|---|---|
| | | | Retention Ratio |
| | Material | Initial Capacity | (50 cycles) |
| Example 1 | 0.25 mol % Bi₂O₃ + LiMn₂O₄ | 99.6 mAh/g | 93.8% |
| Example 3 | 0.25 mol % BiOF + LiMn₂O₄ | 102.3 mAh/g | 95.8% |
| Comparative | LiMn₂O₄ | 100.8 mAh/g | 90.4% |
| Example 1 | | | |
| Example 2 | 0.25 mol % Bi₂O₃ + LiMn_{1.5}Ni_{0.5}O₄ | 135.8 mAh/g | 97.1% |
| Example 4 | 0.25 mol % BiOF + LiMn_{1.5}Ni_{0.5}O₄ | 134.6 mAh/g | 98.4% |
| Comparative | LiMn_{1.5}Ni_{0.5}O₄ | 127.5 mAh/g | 94.2% |
| Example 2 | | | |

Table 1 shows high-temperature cycle life characteristics of the cells including the positive active materials of Examples 1 to 4 and Comparative Examples 1 and 2.

Referring to Table 1, the positive active material of Example 1 had about a 3.4% better capacity retention ratio at 55° C. than that of Comparative Example 1 after 50 cycles, and the positive active material of Example 3 had a 5.4% better capacity retention ratio than that of Comparative Example 1.

In addition, the positive active material of Example 2 had about a 2.9% better capacity retention ratio than that of Comparative Example 2, and the positive active material of Example 4 had a 4.2% better capacity retention ratio than that of Comparative Example 2.

In general, battery cycle life characteristics are changed due to reaction with an electrolyte at a high temperature and dissolution of transition elements included in a positive active material. As shown in Table 1, the positive active materials of Examples 1 to 4, which were surface-modified with a bismuth-based compound, had remarkably improved cycle life characteristics, because they did not have capacity deterioration due to reaction between the electrolyte solution and the positive active material or dissolution of transition elements.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A positive active material for a rechargeable lithium battery, comprising:
an active compound that can intercalate/deintercalate lithium ions; and
a bismuth (Bi)-based compound on the surface of the active compound.

2. The positive active material of claim 1, wherein the bismuth-based compound is selected from the group consisting of bismuth-included oxide, bismuth-included nitride, bismuth-included sulfide, bismuth-included fluoride, a bismuth-included amine compound, a bismuth-included acetate compound, and a mixture thereof.

3. The positive active material of claim 1, wherein the bismuth-based compound is selected from the group consisting of Bi₂O₃, BiOF, BiF₃, BiF₅, NH₄BiF₄, NH₄BiF₆, NH₄Bi₃F₁₀, Bi(C₂H₃O₂)₃, and mixtures thereof.

4. The positive active material of claim 1, wherein the bismuth-based compound is coated as a layer on the surface of the active compound surface.

5. The positive active material of claim 4, wherein the coating layer has a thickness ranging from 3 to 500 nm.

6. The positive active material of claim 5, wherein the coating layer has a thickness ranging from 5 to 500 nm.

7. The positive active material of claim 6, wherein the coating layer has a thickness ranging from 5 to 300 nm.

8. The positive active material of claim 1, wherein the bismuth-based compound is coated as an island shape on the surface of the active compound.

9. The positive active material of claim 8, wherein the bismuth-based compound is coated in an area ranging from 1 to 100% based on 100% of the surface area of the active compound.

10. The positive active material of claim 9, wherein the bismuth-based compound is coated in an area ranging from 5 to 100% based on 100% of the surface area of the active compound.

11. The positive active material of claim 10, wherein the bismuth-based compound is coated in an area of 10 to 100% based on 100% of the surface area of the active compound.

12. The positive active material of claim 1, wherein the active compound is at least one of composite metal oxides represented by the following Formulas 1 to 7:
LiₐNiₓCo_{y}Mn_{z}M_{1-x-y-z}O₂Q_{σ} [Chemical Formula 1]
wherein, in the above Formula 1, M is an element selected from the group consisting of B, Mg, Al, Cr, V, Ti, Fe, Zr, Zn, Si, Y, Nb, Ga, Sn, Mo, W, and combinations thereof, Q is a halogen or sulfur, 1.0≦a≦1.2, 0≦x≦0.95, 0≦y≦0.7, 0≦z≦0.7, 0≦1−x−y−z≦0.3, and 0≦σ≦0.1;
LiₐCO₁₋ₓMₓO₂Q_{σ} [Chemical Formula 2]
wherein, in the above Formula 2, M is an element selected from the group consisting of Mg, B, Al, Cr, V, Ti, Fe, Zr, Zn, Si, Y, Nb, Ga, Sn, Mo, W, and combinations thereof, Q is a halogen or sulfur, 1.0≦a≦1.2, 0≦x≦0.1, and 0≦σ≦0.1;
LiₐMn₁₋ₓMₓO₂Q_{σ} [Chemical Formula 3]
wherein, in the above Formula 3, M is an element selected from the group consisting of B, Mg, Al, Cr, V, Ti, Fe, Zr, Zn, Si, Y, Nb, Ga, Sn, Mo, W, and combinations thereof, Q is a halogen or sulfur, 1.0≦a≦1.2, 0≦x≦0.5, and 0≦σ≦0.1;
LiₐMn₂₋ₓMₓO₄Q_{σ} [Chemical Formula 4]
wherein, in the above Formula 4, M is an element selected from the group consisting of B, Li, Mg, Al, Ca, Sr, Cr, V, Ti, Fe, Co, Ni, Zr, Zn, Si, Y, Nb, Ga, Sn, Mo, W, and combinations thereof, Q is a halogen or sulfur, 1.0≦a≦1.3, 0≦x≦0.2, and 0≦σ≦0.1;
LiₐMn₂₋ₓMₓO₄Q_{σ} [Chemical Formula 5]
wherein, in the above Formula 5, M is an element selected from the group consisting of B, Li, Mg, Al, Ca, Sr, Cr, V, Ti, Fe, Co, Ni, Zr, Zn, Si, Y, Nb, Ga, Sn, Mo, W, and combinations thereof, Q is a halogen or sulfur, 1.0≦a≦1.3, 0.3≦x≦0.7, and 0≦σ≦0.1;
Li₄₊ₐTi₄₋ₓMₓO₁₂Q_{σ} [Chemical Formula 6]
wherein, in the above Formula 6, M is an element selected from the group consisting of Li, Mg, Al, Ca, Sr, Cr, V, Ti, Fe, Co, Ni, Zr, Zn, Si, Y, Nb, Ga, Sn, Mo, W, and combinations thereof, Q is a halogen or sulfur, 0≦a≦0.1, 0≦x≦0.1, and 0≦σ≦0.1; and
LiMₓPO₄Q_{σ} [Chemical Formula 7]
wherein, in the above Formula 7, M is an element selected from the group consisting of Co, Ni, Mn, Fe, Mg, V, Ti, Fe, Zr, Zn, Si, Y, Nb, Ga, Sn, Mo, W, and combinations thereof, Q is a halogen or sulfur, 0≦a≦0.1, 0≦x≦0.1, and 0≦σ≦0.02.

13. A rechargeable lithium battery comprising:
a positive electrode including the positive active material according to claim 1;
a negative electrode including a negative active material; and
a non-aqueous electrolyte.
